(19) United States
(12) Patent Application Publication
(10) Pub. No.: US 2009/0179843 A1
(43) Pub. Date: Jul. 16, 2009

(54) LIGHTING DEVICE WITH AN ARRAY OF CONTROLLED EMITTERS WITH SHARED CONTROL AND FEEDBACK

(75) Inventors: Bernd Ackermann, Aachen (DE); Georg Sauerländer, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/299,134

(22) PCT Filed: Apr. 24, 2007
(86) PCT No.: PCT/IB2007/051503

§ 371 Date: Oct. 31, 2008

(30) Foreign Application Priority Data
May 4, 2006 (EP) 06113523.2

(51) Int. Cl. G09G 3/34

(52) U.S. Cl. 345/89

(57) ABSTRACT

The invention relates to a lighting device that may particularly be used as an LCD backlight and that comprises an array of light emitters (11.1, 11.2) which are optionally separated by optical barriers (13). The light emitters (11.1, 11.2) may particularly be realized by groups of LEDs (12.1, 12.2) of different colors, for example red, green and blue. Local control units (16), driving units (15.1, 15.2), and sensor units (14) are provided to control the individual light output of the light emitters, wherein at least one of these components is shared by two or more light emitters (11.1, 11.2).

The invention relates to a lighting device comprising an array of light emitters, preferably light emitting diodes (LEDs). Moreover, it relates to a backlight for a liquid crystal display (LCD) comprising such a lighting device.

From the US 2005/0058450 A1, an LCD backlight is known that comprises a light guide plate illuminated from its sides by light emitters of different colors, wherein the color is controlled in a feedback loop. In the current rapid evolution of LCD backlights, backlit backlights replace side-lit backlights to increase brightness especially for larger-sized LCDs. Moreover, scanning backlights replace uniformly illuminated backlights to improve the LCD picture quality, eliminate motion artifacts and reduce the system costs. Backlights with local highlighting are proposed as the next step to achieve further improvements like increasing the energy efficiency of the whole system by a more favorable subdivision of the screen than can be achieved with scanning backlights.

Based on this situation it was an object of the present invention to provide a lighting device, particularly for LCDs, that can be produced at low costs while providing a high functional versatility.

This object is achieved by a lighting device according to claim 1 and by an LCD backlight according to claim 14. Preferred embodiments are disclosed in the dependent claims.

According to its first aspect, the invention relates to a lighting device comprising an array of light emitters with associated operating units, i.e. hardware components that are needed to achieve the desired operation of the light emitters. The term “array” shall denote here in the most general sense any one-, two- or three-dimensional arrangement of objects, i.e. of light emitters and/or of associated operating units. In most cases, the array will be a two-dimensional arrangement, preferably a flat arrangement of light emitters and/or associated operating units in a regular (e.g. grid-shaped) pattern. The light emitters are preferably “original” emitters in the sense that they generate light from some other form of energy, e.g. from electrical current. They may be single lamps or units of several, equal or distinct lamps. Moreover, there shall be a group (with at least one member) of “shared” operating units which by definition are functionally associated to at least two light emitters.

The described lighting device has the advantage that hardware components realizing the shared operating units are used by two or even more light emitters, thus saving space and costs while at the same time providing the full functionality of an array with individually controlled light emitters.

The operating units (whether shared or not) may particularly comprise at least one control unit for controlling the light output of its associated light emitter(s), at least one driving unit for driving its associated light emitter(s) with the required energy, and/or at least one sensor unit. The sensor unit may for example measure the color point or brightness of its associated light emitter(s) or a temperature related to their operation.

There are many possible designs in which operating units are shared by light emitters. The following embodiments are of particular importance in this respect:

(i) The shared operating units may comprise at least one control unit for controlling the light output of its associated light emitters according to at least one given target value.

(ii) The shared operating units may comprise at least one sensor unit for measuring a quantity related to the operation of its associated light emitters, particularly to the flux of the emitted light, the color point of the emitted light, or an operating temperature of its associated light emitters.

(iii) The shared operating units may comprise at least one control unit and at least one sensor unit, wherein these units are preferably associated to the same light emitters.

(iv) The shared operating units may comprise at least one control unit and at least one driving unit, wherein these units are preferably associated to the same light emitters.

(v) The shared operating units may comprise at least one control unit, at least one sensor unit, and at least one driving unit, wherein these units are preferably associated to the same light emitters.

The lighting device preferably comprises at least one light emitter that is coupled to at least two shared operating units. As already mentioned, this is typically the case in the above embodiments (iii), (iv), and (v).

The operating units may optionally be located adjacent to their associated one or more light emitters. Thus the traveling distances of signals between the units and the light emitters can be minimized, which also minimizes losses and disturbances. Using appropriate light guiding and wiring, the operating units may however also be placed (almost) arbitrarily in the lighting device. Their actual arrangement typically depends on practical considerations related to the specific construction of the lighting device (e.g. a LCD backlight).

The control units are preferably adapted to control the associated light emitters in a feedback loop comprising at least one associated sensor unit. Thus target values like the color point or brightness of the light emitters can individually be maintained in spite of temperature variations, ageing of components, production spread and the like.

In another embodiment of the invention, at least one control unit is adapted to drive a group of light emitters that are associated to said control unit and that are further associated to one sensor unit in such a way that a time-multiplexed measurement of the individual light output of said light emitters is possible with said sensor unit. This can for example be achieved if the control unit switches all but one light emitter off such that the sensor can measure the individual light output of said single active light emitter. Similarly, all but one light emitter might be switched on such that the difference in measured light output (with respect to an activation of all light emitters) represents the contribution of the switched-off light emitter. Moreover, the light emitters might be driven at different frequencies such that their individual contributions to a sensor signal can be separated in the frequency domain of said signal.

The control units, driving units and sensor units may be realized by any kind of hardware that is suited to fulfill its task in combination with the particular design of the lighting device. The control units may for example comprise a microcontroller, a digital signal processor (DSP), an application specific integrated circuit (ASIC), or a programmable logic.

While the light emitters may in principle be realized by any kind of lamp, it is preferred that they comprise a set of (anorganic or organic) light emitting diodes (LEDs) of different colors, particularly a set of LEDs with the three colors red, green and blue. LEDs have the advantage of a low power consumption while providing excellent light emitting properties.

According to the further development of the lighting device, the light emitters are separated from each other by optical barriers. Such barriers help to concentrate the light emitted by a light emitter to a localized area.

The invention further relates to an LCD backlight comprising a lighting device of the kind described above, i.e. a lighting device including an array of light emitters with associated local control units, local driving units and local sensor units wherein at least some of these units are functionally associated to at least two light emitters. The LCD backlight has similar features like a lighting device as it was described above. For more information on details, advantages and further developments of the LCD backlight reference is therefore made to the description of said lighting device.

These and other aspects of the invention will be apparent from and elucidated with reference to the embodiment(s) described hereinafter. These embodiments will be described by way of example with the help of the accompanying drawings in which:

FIG. 1 shows in a side view (left) and a top view (right) a lighting device that can be used as an LCD backlight according to the present invention;

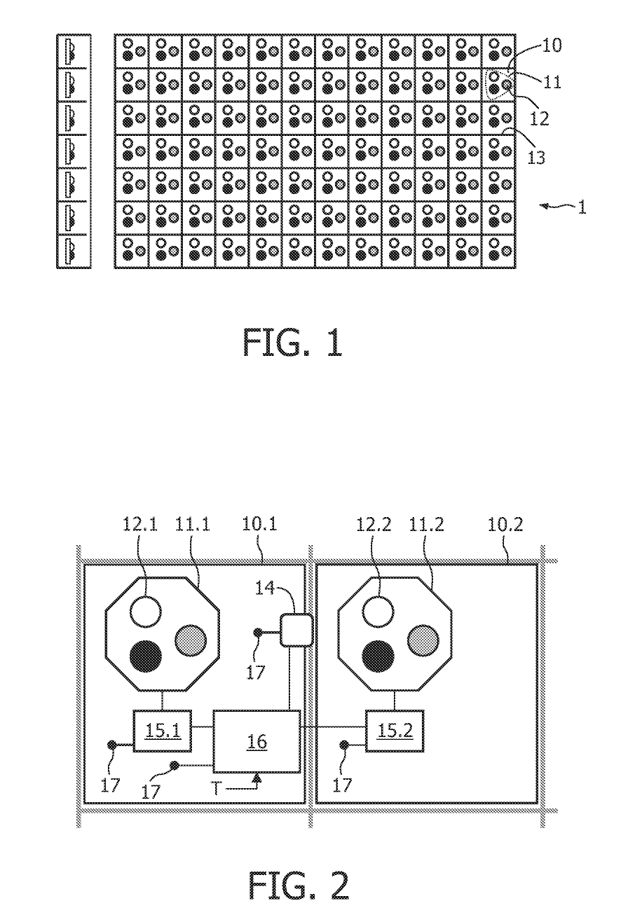

FIG. 2 shows schematically two adjacent segments of a lighting device according to the present invention comprising light emitters, a control unit, driving units and a sensor unit;

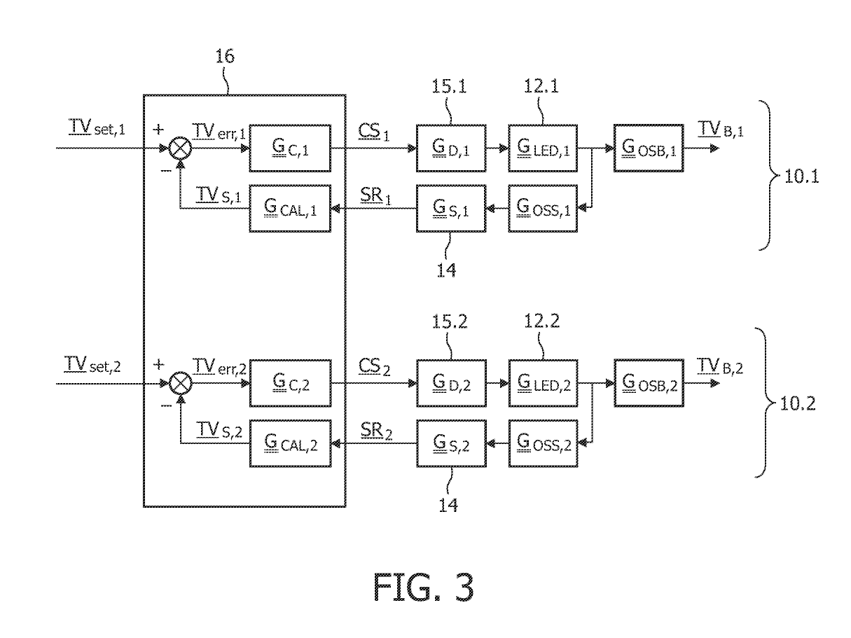

FIG. 3 shows a block diagram of the LED color control system of the two segments shown in FIG. 2.

Like reference numbers in the Figures refer to identical or similar components.

At present, fluorescent lamps—either cold cathode fluorescent lamps CCFL or hot cathode fluorescent lamps HCFL—are the dominant technology for backlit LCD backlights. Usually, several lamps are arranged vertically in the backlight. Each lamp illuminates primarily the area in front of it, but a considerable fraction of the light emitted by it reaches also areas far away from it. Lighting all lamps at the same time results in a uniformly illuminated backlight. Lighting the lamps time-sequentially in an appropriate way results in a scanning backlight. This requires a separate driver and appropriate brightness control for each lamp. The scanning backlight operation can be supported by introducing optical barriers between the lamps in order to reduce the amount of light reaching areas far away from the emitting lamp.

Moreover, LEDs have been introduced in direct-lit backlights. This kind of backlight uses stripes of RGB LEDs, the light emitted by which is appropriately mixed e.g. to obtain white light with a desired color temperature. This requires at least one driver for each of the colors R, G, and B and appropriate color control, including sensors for temperature, light, and/or color. Controlling the color and brightness independently for each LED stripe may be advantageous for achieving a homogenous color and brightness of the backlight. Scanning backlight can be implemented using this independent control of each stripe. Barriers between LED stripes can be added in a way similar to that applied for backlights with fluorescent lamps.

Based on this background, the invention will be described in the following with reference to an LED based LCD backlight. FIG. 1 shows an embodiment of such an LCD backlight 1 comprising 7×12 modules or “segments” 10. Each of said segments 10 comprises a light emitter 11 that is itself composed of three LEDs 12 with the colors red, green and blue (or a single LED that can generate these colors independently). LEDs are ideally suited to implement local highlighting. Moreover, the backlight 1 may comprise optical barriers 13 between the segments 10.

In the backlight 1 shown in FIG. 1, the large number of 7·12=84 segments has to be controlled for local highlighting. Implementing a local color control system for each of them therefore requires a very large number of components. For this reason it is proposed here to use components of the local control systems for the control of two or more associated light emitters 11. Sharing parts of the color control system between neighboring segments reduces significantly the effort (number of components) required for controlling the segments of a LCD backlight.

A realization of the aforementioned concept is shown in more detail in the schematic layout of FIG. 2 which depicts two adjacent segments 10.1, 10.2 of the backlight 1 of FIG. 1. Each of the segments comprises a light emitter 11.1, 11.2 that is composed of three LEDs 12.1, 12.2. Moreover, each segment 10.1, 10.2 comprises a driving unit 15.1, 15.2 for providing the LEDs 12.1, 12.2 with forward currents (e.g. pulse-width or amplitude modulated). The driving units 15.1, 15.2 are coupled to a common control unit 16 that provides them with appropriate control signals and that is located here completely in the segment 10.1. The control unit 16 receives as input target values T (e.g. tristimulus values) for the light output of the associated segments 10.1, 10.2. Whilst each control unit 16 can receive this information directly from a supervisory system, intermediate circuitry for spreading this information in the backlight 1 may be used.

The control unit 16 can be realized for example by a microcontroller, a DSP, an ASIC, or a programmable logic. It is further coupled to a single sensor unit 14, for example a photodiode, that can measure the light output (e.g. flux, color) of both light emitters 11.1, 11.2. Two or more segments can share one sensor e.g. by time multiplexing. Alternatively or additionally to flux and/or color sensors, one or more temperature sensors may also be used. They could for example comprise a global temperature sensor measuring the temperature of a (common) heat sink and/or local temperature sensors measuring the temperature of the individual light emitters 11.1, 11.2 or even individual LEDs 12.1, 12.2 (e.g. via their current/voltage characteristics). All kinds of intermediate schemes are of course also conceivable, e.g. measuring individually the temperature of each of a number of separate heat sinks used in large backlights.

Power has to be supplied to each sensor unit 14, driving unit 15.1, 15.2 and control unit 16. This is indicated in the Figure by connecting lines to some power source 17. While there could be power supplies associated to the individual segments 10.1, 10.2, it may be preferred that groups of (all) sensor unit(s) share a power supply, groups of (all) driving unit(s) share a power supply, and groups of (all) control unit(s) share a power supply.

Thus there is one control unit 16 and one sensor unit 14 associated to two light emitters 11.1, 11.2. In a similar way, a multiple output driver could be used to drive the LEDs of two or more segments.

FIG. 3 shows the logical block diagram of the control system implemented in the device of FIG. 2. Color and brightness are controlled independently for each segment 10.1, 10.2 using the single control unit 16 and the single color sensor 14. A supervisory system defines the color and brightness of the light to be produced by the segments, e.g. in terms of tristimulus values TV_{set,1}=(X_{set,1}, Y_{set,1}, Z_{set,1}) and TV_{set,2}=(X_{set,2}, Y_{set,2}, Z_{set,2}). Comparing these to the sensed tristimulus values TV_{s,1} and TV_{s,2} results in the tristimulus value errors TV_{err,1} and TV_{err,2}. The two control functions G_{C,1} and G_{C,2} implemented by the controller 16 determine from the tristimulus value errors the control signals CS₁=(CS_{r,1}, CS_{g,1}, CS_{b,1}) and CS₂=(CS_{r,2}, CS_{g,2}, CS_{b,2}) to be applied to the LED drivers 15.1 and 15.2 having the transfer functions G_{D,1} and G_{D,2}. The drivers generate corresponding currents through the LEDs 12.1 and 12.2 having the transfer functions G_{LED,1} and G_{LED,2} that create the desired light. In general, light transmission G_{OSB,1} and G_{OSB,2} from the LEDs to the backlight will be different from light transmission G_{OSS,1} and G_{OSS,2} from the LEDs to the sensor 14 (which has the transfer functions G_{S,1} and G_{S,2}). Therefore, calibrations G_{CAL.1} and G_{CAL,2} have to be applied to the sensor readings SR₁=(R₁, G₁, B₁) and SR₂=(R₂, G₂, B₂).

Although FIGS. 2 and 3 are related to two segments sharing parts of the color control system, this can straightforwardly be extended to several segments. The segments sharing parts of the color control system can be considered and produced as a module. Alternatively, one segment can carry the shared parts of the color control system and the other segments making use of the shared parts be linked to this segment (cf FIG. 2).

In summary, the invention describes LED based LCD backlights with local highlighting and scanning features that improve the LCD picture quality, increase the energy efficiency of the system, eliminate motion artifacts and reduce the system costs by a more favorable subdivision of the backlight light source. The effort of implementing driving and color control for each of a large number of segments is reduced significantly by sharing parts of the driving and color control system between neighboring segments. A lighting device according to the present invention can however not only be applied as an LCD backlight, but for example also to flat light sources for general illumination with display like variation of light emitted from their surface.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A lighting device (1), comprising an array of light emitters (11, 11.1, 11.2) with associated operating units (14, 15.1, 15.2, 16), wherein there is a group of shared operating units (14, 16) that are functionally associated to at least two light emitters (11.1, 11.2).

2. A lighting device (1) according to claim 1,
characterized in that the operating units comprise at least one control unit (16), driving unit (15.1, 15.2), and/or sensor unit (14).

3. A lighting device (1) according to claim 2,
characterized in that the shared operating units comprise at least one control unit (16) for controlling the light output of its associated light emitters (11.1, 11.2) according to at least one given target value (T).

4. A lighting device (1) according to claim 2,
characterized in that the shared operating units comprise at least one sensor unit (14) for measuring a quantity related to the operation of its associated light emitters (11.1, 11.2), particularly to the flux of the emitted light, the color point of the emitted light, or an operating temperature.

5. A lighting device (1) according to claim 2,
characterized in that the shared operating units comprise at least one control unit (16) and at least one sensor unit (14).

6. A lighting device (1) according to claim 2,
characterized in that the shared operating units comprise at least one control unit (16) and at least one driving unit.

7. A lighting device (1) according to claim 2,
characterized in that the shared operating units comprise at least one control unit (16), at least one sensor unit (14), and at least one driving unit.

8. A lighting device (1) according to claim 1,
characterized in that it comprises at least one light emitter (11.1, 11.2) that is coupled to at least two shared operating units (14, 16).

9. The lighting device (1) according to claim 2,
characterized in that each control unit (16) is adapted to control the associated light emitters (11.1, 11.2) in a feedback loop comprising at least one associated sensor unit (14).

10. The lighting device (1) according to claim 2,
characterized in that at least one control unit (16) is adapted to drive a group of associated light emitters (11.1, 11.2) that are further associated to a common sensor unit (14) such that a time-multiplexed measurement of their individual light outputs is possible.

11. The lighting device (1) according to claim 2,
characterized in that the control units (16) comprise a microcontroller, a DSP, an ASIC, or a programmable logic.

12. The lighting device (1) according to claim 1,
characterized in that at least one light emitter comprises a set of LEDs (12.1, 12.2) of different colors, particularly red, green and blue LED.

13. The lighting device (1) according to claim 1,
characterized in that the light emitters (11.1, 11.2) are separated from each other by optical barriers (13).

14. An LCD backlight, comprising a lighting device (1) according to claim 1.
